(19) United States
(12) Patent Application Publication
(10) Pub. No.: US 2004/0214009 A1
(43) Pub. Date: Oct. 28, 2004

(54) Adhesion promoting technique

(76) Inventor: Ebrahim Andideh, Portland, OR (US)

Correspondence Address: Lester J. Vincent, BLAKELY, SOKOLOFF, TAYLOR & ZAFMAN LLP, Seventh Floor, 12400 Wilshire Boulevard, Los Angeles, CA, 90025-1026, US

(21) Appl. No.: 10/425,770

(22) Filed: Apr. 28, 2003

(51) Int. Cl. B05D 3/12

(52) U.S. Cl. 428/421; 427/314; 427/569; 427/240

(57) ABSTRACT

A technique to promote the adhesion and uniform distribution of a spin coated film upon a ferroelectric material. At least one embodiment of the invention uses a ferroelectric material, such as PVDF/TrFE, to promote the adhesion of a spin-coated film onto a wafer.

### FIELD

Embodiments of the invention relate to semiconductor manufacturing process. More particularly, embodiments of the invention relate to a technique for promoting the adhesion of a film to a hydrophobic surface of a material.

### BACKGROUND

In modern semiconductor processing, films, such as conductive polymers, can be deposited upon materials, such as vinylidene fluoride/trifluoroethylene (“PVDF/TrFE”), through a technique known as “spin-coating.” Prior art spin-coating techniques typically apply a film to a wafer surface by pouring the film onto the wafer while the wafer is spun to apply the film evenly across the wafer. Ferroelectric materials, such as PVDF/TrFE, however, are substantially hydrophobic and, therefore, do not typically bond with a spin-coated film easily.

FIG. 1 illustrates a top view of a wafer on which a film has been spin-coated upon a ferroelectric material by a prior art technique. The interface between the film and the ferroelectric material may be interrupted with areas of poor adhesion 101, because the hydrophobic properties of the ferroelectric surface prevent the film from bonding, and therefore depositing, uniformly across the wafer.

### BRIEF DESCRIPTION OF THE DRAWINGS

Embodiments of the invention are illustrated by way of example and not limitation in the figures of the accompanying drawings, in which like references indicate similar elements and in which:

FIG. 1 illustrates a top view of a wafer on which a prior art technique has been used to deposit a spin-coated film upon a ferroelectric material.

FIG. 2 illustrates a side view of a wafer on which a technique has been used to deposit a spin-coated film upon a ferroelectric material according to one embodiment of the invention.

FIG. 3 is a flow chart illustrating a portion of a semiconductor manufacturing process that may be used to perform a technique for spin-coating a film upon a ferroelectric material uniformly according to one embodiment of the invention.

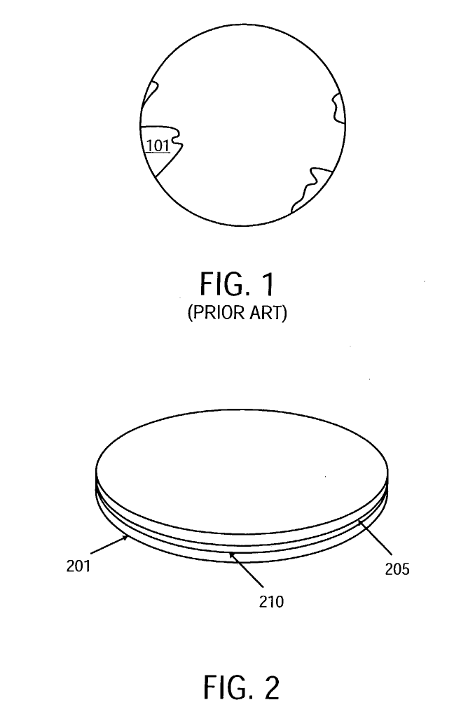

### DETAILED DESCRIPTION

Embodiments of the invention described herein relate to complementary metal-oxide-semiconductor (“CMOS”) processing. More particularly, embodiments of the invention relate to a technique to promote the adhesion and uniform distribution of a spin-coated film upon a ferroelectric material.

In order to improve the adhesion of a spin-coated film upon a ferroelectric material, such as PVDF/TrFE, the ferroelectric material surface upon which the spin-coated film is to be deposited is converted from a substantially hydrophobic surface to a more hydrophilic surface according to at least one embodiment of the invention. A hydrophilic surface typically has a higher capacity to absorb and bond with a liquid than does a hydrophobic surface, which can help a liquid, such as a spin-coated film, bond to a surface, such as that of a ferroelectric material, and therefore help improve the uniformity of the film thickness across the surface of the wafer.

For example, FIG. 2 illustrates a side view of a wafer 201 and a spin-coated film 205 deposited on a ferroelectric material 210, such as PVDF/TrFE. The interfacing surface between the ferroelectric material and the film has been converted from a substantially hydrophilic surface to a more hydrophilic surface, so as to promote adhesion between the film and the interfacing surface of the ferroelectric material. Advantageously, the spin-coated film is distributed more uniformly across the wafer than in the prior art, as a result of the surface of the ferroelectric material becoming more hydrophilic before the film was deposited. The uniformity of the film typically helps improve quality and reliability of devices that are formed on the wafer.

The substantially hydrophobic surface of the ferroelectric material is converted into a more hydrophilic surface, in one embodiment of the invention, by exposing the surface of the ferroelectric material to a low power, high-pressure plasma of helium, oxygen, nitrogen, argon, xenon, krypton, or any combination of these for five to fifty seconds. Typically, the power of the helium plasma is 1000 W or less, whereas the environmental pressure surrounding the ferroelectric material is typically greater than 2 milli-Torr (mTorr). The particular amount of time of exposure, the power of the helium plasma, and the environmental pressure depends in part on other process factors, such as size of the wafer, ferroelectric material used, and thickness and type of film being spin-coated onto the ferroelectric material. Furthermore, plasma treatment may be performed during a reactive ion etch (“RIE”) operation, in which a substrate having a ferroelectric polymer material resides on a biased pedestal. In other embodiments of the invention, the substrate is placed on a grounded or floating pedestal and perform the treatment by starting a plasma operation.

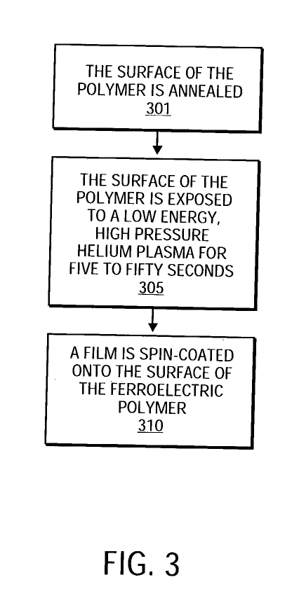

FIG. 3 illustrates a technique to make a ferroelectric polymer, such as PVDF/TrFE, more hydrophilic in order to promote adhesion between the polymer and a spin-coated film deposited thereon according to one embodiment of the invention. At operation 301, the surface of the polymer is annealed. At operation 305, the surface of the polymer is exposed to a low energy, high-pressure helium plasma for five to fifty seconds in order to make the polymer surface more hydrophilic and therefore increase the uniformity of the spin-coated film to be deposited thereon. At operation 310, a film is spin-coated onto the surface of the ferroelectric polymer.

While the invention has been described with reference to illustrative embodiments, this description is not intended to be construed in a limiting sense. Various modifications of the illustrative embodiments, as well as other embodiments, which are apparent to persons skilled in the art to which the invention pertains are deemed to lie within the spirit and scope of the invention.

What is claimed is:

1. A method comprising:
annealing a ferroelectric material (FEM) surface;
exposing the FEM surface to a helium plasma;
spin-coating a film upon the FEM surface.

2. The method of claim 1 wherein the FEM surface is exposed to the helium plasma from five to fifty seconds.

3. The method of claim 2 wherein the FEM surface is exposed to a plasma chosen from any combination of a group consisting of helium, oxygen, nitrogen, argon, xenon, and krypton, at an atmospheric pressure of at least 2 mTorr.

4. The method of claim 3 wherein the helium plasma has a power of no greater than approximately 1000 W.

5. The method of claim 1 wherein the exposure of the FEM surface to the helium plasma results in the FEM surface being more hydrophilic than before the exposure of the FEM surface to the helium plasma.

6. The method of claim 5 wherein the exposure of the FEM surface to the helium plasma results in the film being able to be more uniformly spin-coated on the FEM surface than before the exposure of the FEM surface to the helium plasma.

7. The method of claim 1 wherein the FEM is poly-vinylidene fluoride/trifluoroethylene polymer.

8. An apparatus comprising:
a first material comprising poly-vinylidene fluoride/trifluoroethylene (PVDF/TrFE);
a spin-coated film of a second material affixed to a surface of the first material.

9. The apparatus of claim 8 wherein the spin-coated film is affixed to the first material by a bond promoted as a result of the surface of the first material being exposed to helium plasma for five to fifty seconds.

10. The apparatus of claim 9 wherein the bond is promoted as the result of the exposure of the surface of the first material to a plasma in an atmospheric pressure of at least 2 mTorr.

11. The apparatus of claim 10 wherein the bond is promoted as the result of the helium plasma having a power of no greater than 1000 W.

12. The apparatus of claim 11 wherein the bond is promoted as the result of the surface of the first material being exposed to a plasma after an anneal process.

13. The apparatus of claim 8 wherein the first material is a ferroelectric polymer.

14. The apparatus of claim 13 wherein the second material is a type of material chosen from a group consisting of a conductive material, a semiconductor material, and an insulating material.

15. A process comprising:
converting a substantially hydrophobic ferroelectric material (FEM) surface to a more hydrophilic FEM surface, the converting including: annealing the substantially hydrophobic FEM surface;
exposing the substantially hydrophobic FEM surface to a plasma having an energy of less than 1000 Watts for approximately five to fifty seconds under atmospheric pressure of at least 2 mTorr;
spin-coating a film upon the substantially hydrophilic FEM surface.

16. The process of claim 15 wherein the film is coupled to the substantially hydrophilic FEM surface by a bond promoted as a result of exposing the substantially hydrophobic FEM surface to the a plasma.
